(19) United States
(12) Patent Application Publication
(10) Pub. No.: US 2010/0018402 A1
(43) Pub. Date: Jan. 28, 2010

(54) Thermostatic brewing mechanism

(76) Inventor: Tsung-Hsi Liu, Taipei City (TW)

Correspondence Address: JACKSON WALKER, L.L.P., 112 E. PECAN, SUITE 2400, SAN ANTONIO, TX, 78205, US

(21) Appl. No.: 12/220,502

(22) Filed: Jul. 25, 2008

(51) Int. Cl. A47J 31/56

(52) U.S. Cl. 99/281

(57) ABSTRACT

A brewing mechanism has a pump, a pipe assembly, a boiler, a supply pipe, a heat exchanger, a feed pipe, a hot water pipe, a brewing group and thermoregulating group. The pipe assembly and the supply pipe both connect to the pump. The boiler is connected to the supply pipe and has a reservoir. The heat exchanger is mounted through the reservoir of the boiler. The feed pipe is mounted between the heat exchanger and pipe assembly. The hot water pipe connects the heat exchanger. The brewing group connects to the hot water pipe. The thermoregulating group is mounted between the brewing group and the pipe assembly. The brewing mechanism has advantages of being more thermostatic by the thermoregulating group directly introducing water into the brewing group.

### BACKGROUND OF THE INVENTION

1. Field of the Invention

The present invention relates to a brewing mechanism for coffee, tea or other beverage brewing, especially a brewing mechanism with improved temperature control.

2. Description of the Prior Arts

A brewing mechanism is used in a coffee brewing machine for brewing a beverage such as espresso, coffee, tea and the like.

With reference to FIG. 8, a conventional brewing mechanism comprises a pump (100), a boiler (110), a heat exchanger (120), a cold water pipe (130), a supply pipe (140), a return tube (150), a hot water pipe (160), a brewing group (170), a thermoregulating pipe (180) and a pressure controller (190).

The boiler (110) has a reservoir. The reservoir can be filled with water to a two-thirds volume thereof. The rest space of the reservoir accommodates steam generated from water heated in the reservoir. The heat exchanger (120) is mounted through the boiler ( 110), exposed to the reservoir and has an inlet, an outlet, a three-way tube (121) being mounted on the inlet of the heat exchanger (120), and a tube insert (122) being connected to the three-way tube (121) and communicating with the heat exchanger (120). The cold water pipe (130) is mounted between the pump (100) and three-way tube (121) and communicates with the tube insert (122). The supply pipe (140) is mounted between the pump (100) and the boiler (110) to transfer water from pump (100) to the reservoir of the boiler (110). The return tube (150) is connected to the three-way tube (121) and communicates with the tube insert (122) and the heat exchanger (120). The hot water pipe (160) is connected to the outlet of the heat exchanger (120). The brewing group (170) is mounted between and connected to the hot water pipe (160) and the return tube (150) and has electromagnetic valve (171) and a filter (172). The thermoregulating pipe (180) is mounted between the hot water pipe (160) and the cold water pipe (130). The pressure controller (190) is mounted on the boiler (110) to control heating function of the boiler (110).

When in use, water is pumped in sequence through the pump (100), the cold water pipe (130), the heat exchanger (120), the hot water pipe (160) and the brewing group (170). Water flows through the cold water pipe (130) and then flows into the thermoregulating pipe (180) and converges with water from the hot water pipe (160) to the brewing group (170).

When the conventional brewing mechanism is standby, the boiler (110) is active to heat water in the reservoir. The water passing through the heat exchanger (120) undergoes heat exchange. The water is evaporated into steam and further enters the brewing group (170) through the hot water pipe (160). Then the steam is condensed into water and then return to the heat exchanger (120) sequentially through the return tube (150), the three-way tube (121) and the tube insert (122), whereby the temperature of the brewing group (170) can be raised to a desired temperature. The brewing group (170) is prewarmed by the repetitive aforesaid processes so as to be ready for brewing coffee, tea or other beverage at a predetermined high temperature.

When the conventional brewing mechanism is active, the pump (100) and the electromagnetic valve (171) of the brewing group (170) as well as the boiler is active. Water enters the cold water pipe (130) through the pump (100) and enters the tube insert (122) and heat exchanger (120). The water prewarmed by the heat exchanger (120) at the standby state and then flowing into the hot water pipe (160) and the water prewarmed by the heat exchanger (120) and then returning the return tube (150) converge on the brewing group (170) and finally enters the filter (172) to finish brewing.

For brewing coffee, tea or other beverage at an optimal temperature, conventional brewing mechanism are designed to equip with a thermoregulating pipe (180) mounted between the cold water pipe (130) and hot water pipe (160) for converging cold water into hot water pipe (160) to adjust temperature of water.

However, the conventional brewing mechanism has the following disadvantages:

First, when the pump (100) and the electromagnetic valve (171) of the brewing group (170) is active, the cold water flows through tube insert (122). The water enters the heat exchanger (120) and mixes with the water in heat exchanger (120). Then the water further flows into the hot water pipe (160) and return tube (150) and then further converge in the brewing group (170) again. Therefore, water flows out the brewing group (170) at the very beginning is with highest temperature. The water will have a stable temperature only after a period of heat exchanging processing.

Second, when the conventional brewing mechanism is used to brew beverage of various concentrations, different quantity of water is required. Because the quantity of the water are varied, the temperature of water being heated in the heat exchanger (120) and then entering the hot water pipe (160) and brewing group (170) would also be varied, which results in an unstable temperature of water in the brewing group (170).

Third, the temperature of the water entering the brewing group (170) may be adjusted by the thermoregulating pipe (180). However, the thermoregulating pipe (180) introduces not only hot water returning from the heat exchanger (120) through the return tube (150), but also cold water from the pump (100) through the cold water pipe (130) into the brewing group (170). The temperature of water entering the brewing group (180) from the hot water pipe (160) and return tube (180) is unstable. Collectively, the conventional brewing mechanism fails to be thermostatic. Moreover, when the conventional brewing mechanism is used for brewing beverage of larger volume, the temperature of water entering the brewing group (170) might fall down with a serial of actions of brewing due to insufficient heat exchanging surface of the heat exchanger (120) of the conventional brewing mechanism.

To overcome the shortcomings, the present invention provides a thermostatic brewing mechanism to mitigate or obviate the aforementioned problems.

### SUMMARY OF THE INVENTION

The main objective of the invention is to provide a brewing mechanism that has property of being more thermostatic than a conventional brewing mechanism.

The brewing mechanism in accordance with the present invention has a pump, a pipe assembly, a boiler, a supply pipe, a heat exchanger, a feed pipe, a hot water pipe, a brewing group and thermoregulating group. The pipe assembly and the supply pipe both connect to the pump. The boiler is connected to the supply pipe and has a reservoir. The heat exchanger is mounted through the reservoir of the boiler. The feed pipe is mounted between the heat exchanger and pipe assembly. The hot water pipe connects the heat exchanger. The brewing group connects to the hot water pipe. The thermoregulating group is mounted between the brewing group and the pipe assembly. The brewing mechanism in accordance with the present invention has advantages of being more thermostatic by the thermoregulating group directly introducing water into the brewing group.

Other objectives, advantages and novel features of the invention will become more apparent from the following detailed description when taken in conjunction with the accompanying drawings.

### BRIEF DESCRIPTION OF THE DRAWINGS

FIG. 1 illustrates a first embodiment of a brewing mechanism in accordance with the present invention;

FIG. 2 illustrates a second embodiment of a brewing mechanism in accordance with the present invention;

FIG. 3 illustrates a third embodiment of a brewing mechanism in accordance with the present invention;

FIG. 4 illustrates a forth embodiment of a brewing mechanism in accordance with the present invention, showing the blade being unlocked;

FIG. 5 illustrates a fifth embodiment of a brewing mechanism in accordance with the present invention;

FIG. 6 illustrates a sixth embodiment of a brewing mechanism in accordance with the present invention;

FIG. 7 illustrates a seventh embodiment of a brewing mechanism in accordance with the present invention; and

FIG. 8 illustrates a conventional brewing mechanism in accordance with the prior art.

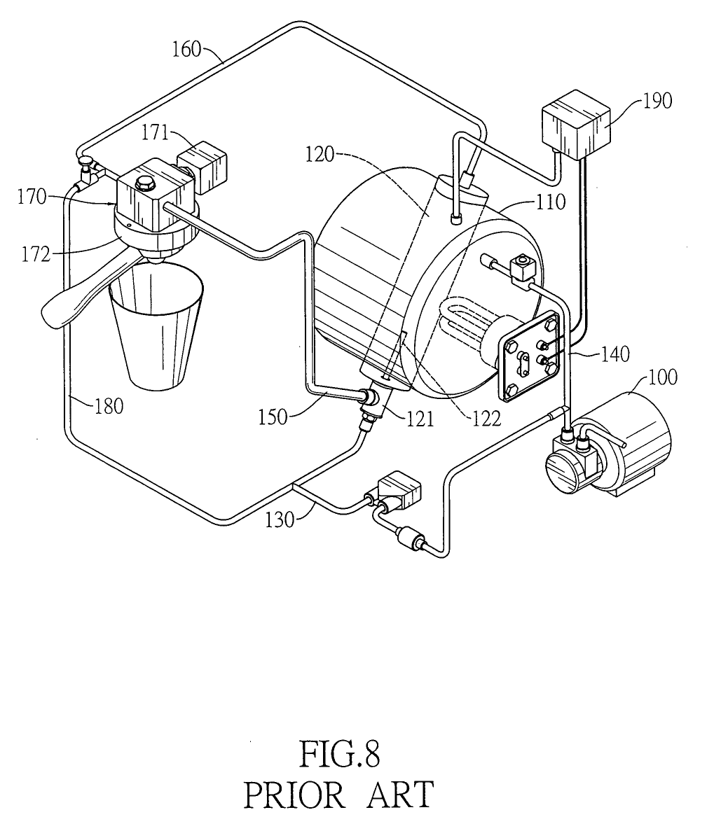

### DETAILED DESCRIPTION OF THE PREFERRED EMBODIMENTS

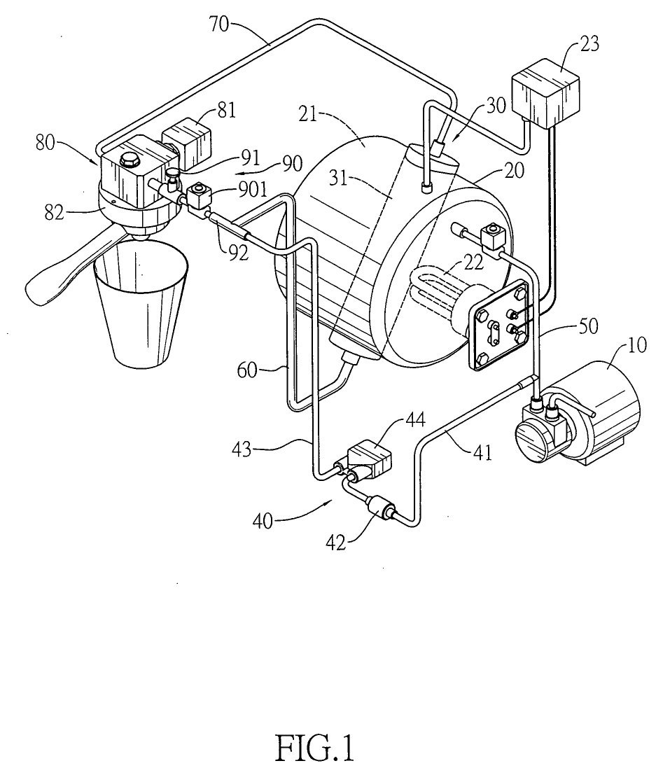

With reference to FIG. 1, a brewing mechanism in accordance with the present invention comprises a pump (10), a pipe assembly (40), a boiler (20), a heat exchanger (30), a supply pipe (50), a feed pipe (60), a hot water pipe (70), a brewing group (80) and a thermoregulating group (90).

The pump (10) has an inlet and an outlet. Water can be pumped into the pump (10) through the inlet of the pump (10).

The pipe assembly (40) is connected to the pump (10) and has an input pipe (41), a check valve (42), an output pipe (43) and a flow meter (44). The input pipe (41) is connected to the outlet of pump (10). The check valve (42) is mounted in the input pipe (41). The output pipe (43) is connected to the input pipe (41). The flow meter (42) is mounted between the input pipe (41) and the output pipe (43) to measure the flow rate of water running through.

The boiler (20) is connected to the pump (10) and has a reservoir (21), a heating coil (22) and a pressure controller (23). The reservoir (21) is connected to the pump (10). The heating coil (22) is mounted in the reservoir (21) to heat the water in the reservoir (21) and evaporate the water into steam. The pressure controller (23) is mounted in the reservoir (21) to detect steam pressure in an upper part of the reservoir (21) and selectively switches on and off the heating coil (22).

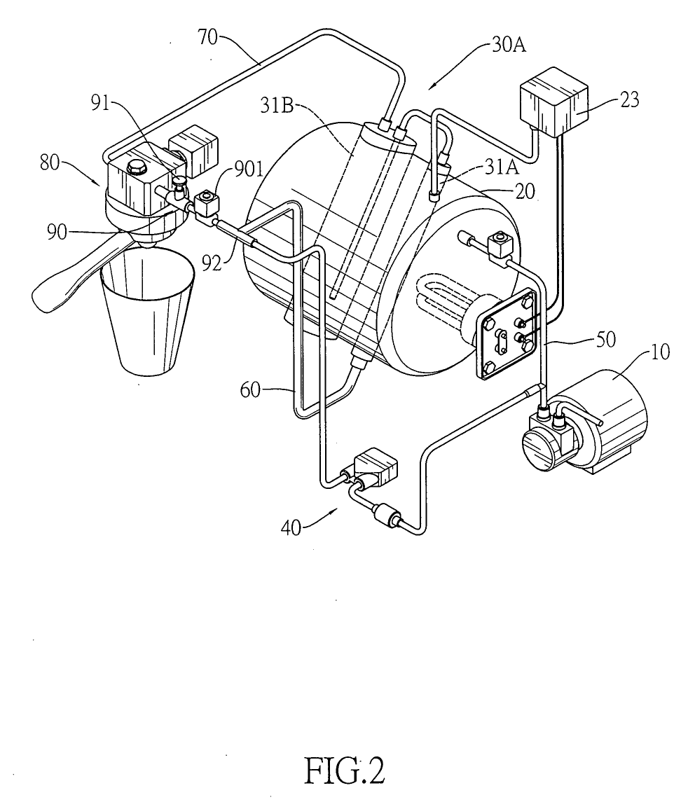

With reference in FIG. 2, the heat exchanger (30) is mounted in the boiler (20) and has an inlet, an outlet and at least one heat exchanging unit (31) and may have more than two heat exchanging units (31A, 31B). Each heat exchanging unit (31, 31A, 31B) is mounted through the reservoir. The heat exchanging units (31, 31A, 31B) are connected each other in serial.

The supply pipe (50) is mounted between the outlet of the pump (10) and the reservoir (21) of the boiler (20).

The feed pipe (60) is mounted between the inlet of the heat exchanger (30) and pipe assembly (40).

The hot water pipe (70) is connected to the outlet of the heat exchanger (30).

The brewing group (80) is connected to the hot water pipe (70) and has an electromagnetic valve (81) and a filter (82). Water flows through the hot water pipe (70) and the filter (82) to brew coffee powders or tealeaves deposited in the filter (82).

The thermoregulating group (90) is mounted between the brewing group (80) and the feed pipe (60) to introduce water from the pipe assembly (40) into the brewing group (80) and to adjust the temperature of water entering the brewing group (80). The thermoregulating group (90) may have a thermoregulating pipe (92), a flow control device and a cutoff device (901).

The thermoregulating pipe (92) connects to the feed pipe (60), the output pipe (43) of the pipe assembly (40), and the brewing group (80).

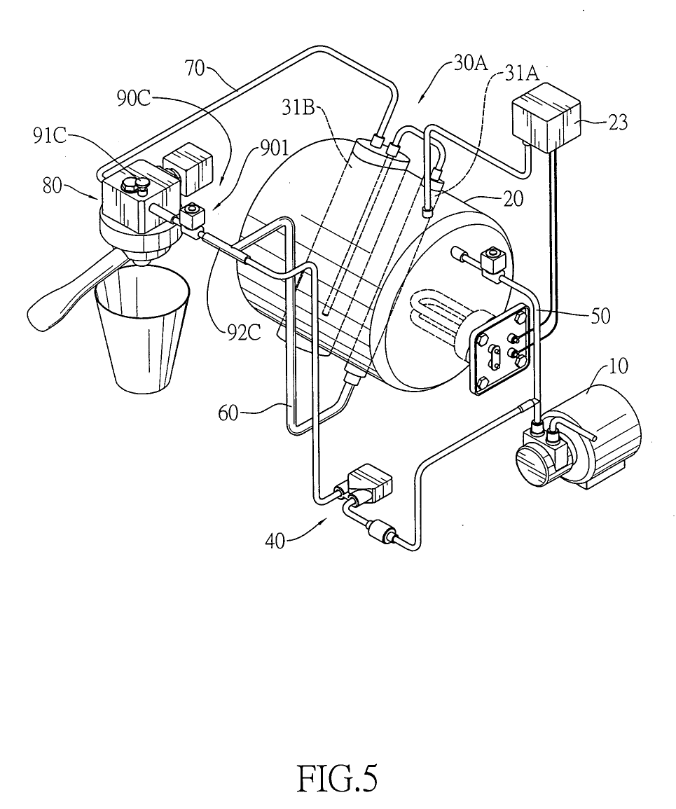

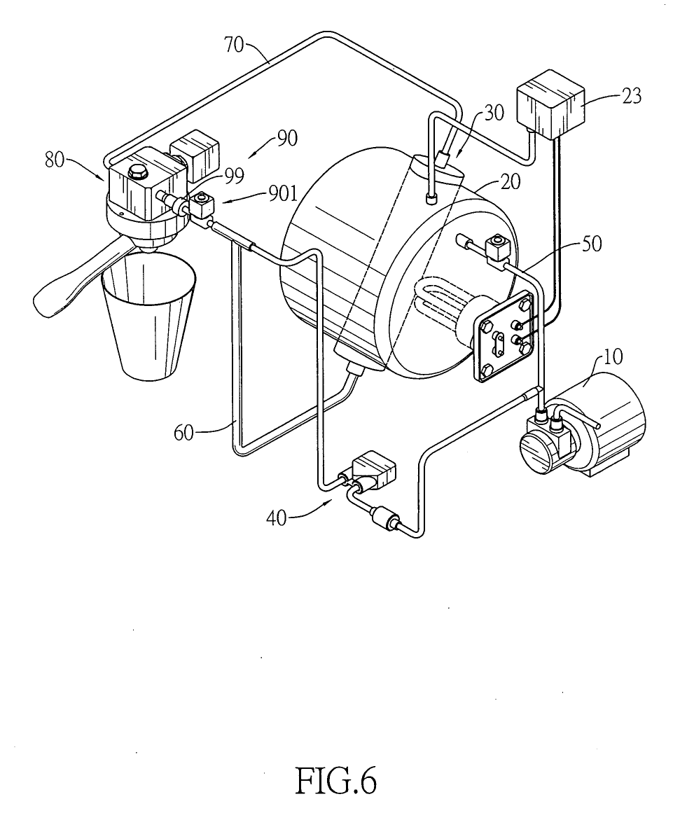

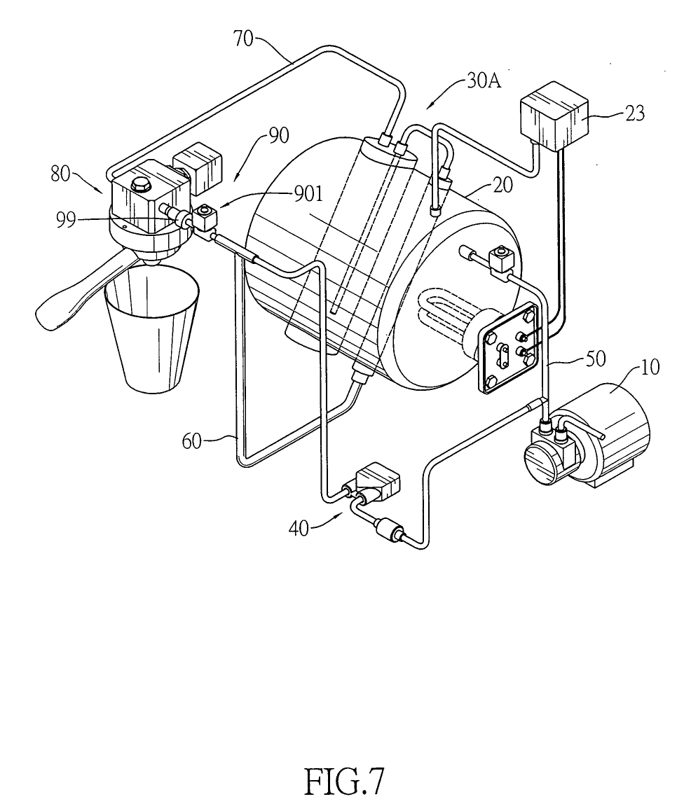

With reference to FIGS. 1 to 5, the flow control device is mounted between the thermoregulating pipe (92) and the brewing group (80) and may be a throttle valve (91, 91A, 91B, 91C). With further reference to FIGS. 6 and 7, the flow control device may be a throttle connector (99).

The cutoff device (901) is mounted between the pipe assembly (40) and the brewing group (80) and is preferably mounted between the pipe assembly (40) and the flow control device (91, 91A, 91B, 91C). The cutoff device (901) selectively blocks water from the pipe assembly (40) and may be a normally open electromagnetic valve. When the cutoff device (901) is active, water from the pipe assembly (40) is blocked from entering the brewing group (80), whereby water entering the brewing group (80) totally comes from the hot water pipe (70).

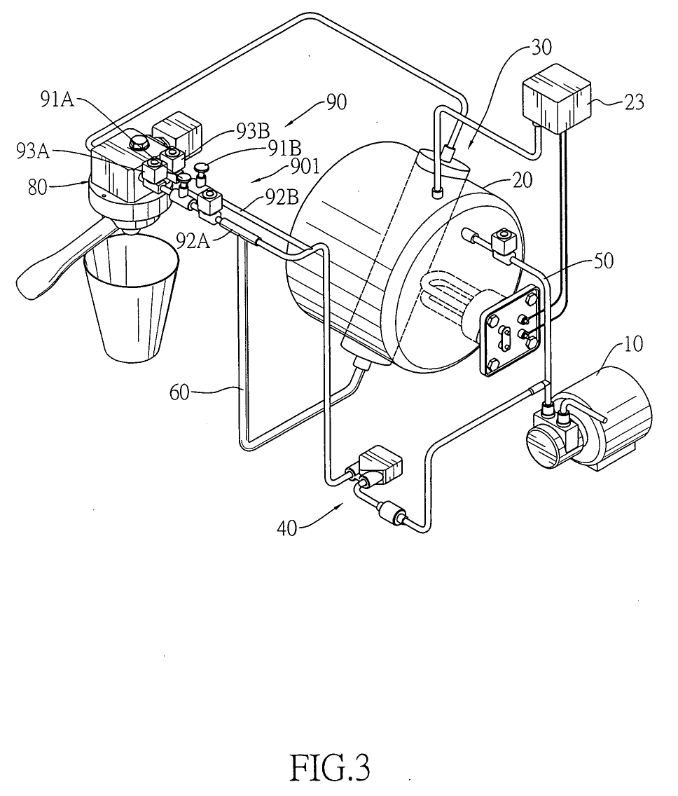

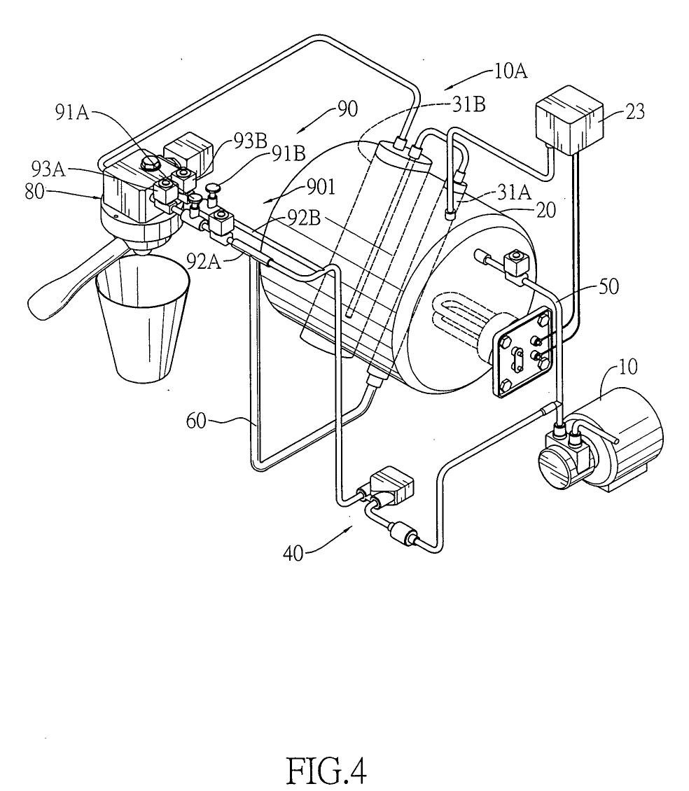

In one of the preferred embodiment of the present invention, with reference to FIGS. 3 and 4, the thermoregulating group (90) has two flow control devices, a thermoregulating pipe (92A), a branch pipe (92B) and two electromagnetic valves (93A, 93B). The thermoregulating pipe (92A) is mounted between the brewing group (80), the pipe assembly (40) and the feed pipe (60). The branch pipe (92B) is mounted between the brewing group (80) and the pipe assembly (40). The flow control devices are two throttle valves (91A, 91B). The throttle valves (91A, 91B) are respectively connected to the thermoregulating pipe (92A) and branch pipe (92B). The electromagnetic valves (93A, 93B) are respectively mounted between the throttle valves (91A, 91B) and the brewing group (80).

When the brewing mechanism in accordance with the present invention is standby, a prewarming process is operated. The water is delivered into the supply pipe (50) and the heat exchanger (30) by the pump (10). The water undergoes heat exchange with the boiler (20) through the heat exchanger (30) and is evaporated into steam. The reservoir (21) of the boiler (20) is filled with two-thirds volume of water to leave an upper part of the reservoir (21) for accommodating steam. The pressure of the steam is monitored by the pressure controller (23) to selectively switch on or off the heat coil (22). The threshold of the steam pressure may be at for example 1 to 1.2 bar. Thus the water in the heat exchanging unit (31) of the heat exchanger (30) is heated. The steam generated in the heat exchanger (30) enters the hot water pipe (70) and the brewing group (80) cools down and condenses into water. Then the water returns to the heat exchanging unit (31) of the heat exchanger (30). As described, the prewarming process for the brewing group (80) is finished to maintain the brewing group (80) at a determined temperature.

When the brewing mechanism in accordance with the present invention is active, the pump (10) and the electromagnetic valve (81) of the brewing group (80) is operated to allow water being pumped into the heat exchanging unit (31) of the heat exchanger (30) in the reservoir (21). Water enters the pipe assembly (40) from the pump (10) and flows into both the feed pipe (60) and the thermoregulating group (90). A portion of water entering the pipe assembly (40) flows into the heat exchanging unit (31) of the heat exchanger (30) through the feed pipe (60) and mixes with the water prewarmed in the heat exchanger (30). The water further enters the brewing group (80) through the hot water pipe (70) and finally enters the filter (82) to finish brewing. The other portion of the water entering the pipe assembly (40) flows into the thermoregulating group (90) and further enters the brewing group (80) to adjust temperature of water flowing into the brewing group (80) through the hot water pipe (70).

When the brewing mechanism in accordance with the present invention is started at initial, in order to rapidly raise the temperature of brewing group (80) to a desired temperature, communication between the pipe assembly (40) and the brewing group (80) is blocked by turning on the cutoff device (901) of the thermoregulating group (90). Therefore, all of the water entering the brewing group (80) is supplied from the hot water pipe (80), such that the temperature of the brewing group (80) reaches a desired temperature quickly without receptive processes for prewarming the brewing group (80). After the desired temperature is reached, the cutoff device (901) of the thermoregulating group (90) is shut down to allow the water without being heated to pass through the thermoregulating group (90) and enter the brewing group (80).

With reference to FIGS. 3 and 4, in another preferred embodiment of the present invention, the electromagnetic valve (93A) is normally open and the electromagnetic valve (93B) is normally closed. The throttle valves (91A, 91B) are adjusted to allow the flow through the thermoregulating pipe (92A) and branch pipe (92B) in a proper proportion relative to each other. Therefore, the water entering the brewing group (80) has two different temperatures for various condition to brew different beverage, for example, 95° C. for coffee, black tea and 85° C. for green tea. When the brewing mechanism in accordance with the present invention is set up to provide 95° C. water, the two electromagnetic valves (93A, 93B) are inactive, and one electromagnetic valve (93A) allow water to pass through and to mix with water from the hot water pipe (70) into 95° C. water. When the electromagnetic valves (93A, 93B) are active, the electromagnetic valve (93A) is closed and the electromagnetic valve (93B) is opened. The electromagnetic valve (93B) allow water to pass through and to mix with water from the hot water pipe (70) into 85° C. water.

Accordingly, the present invention provides a brewing mechanism has advantages as followings:

First, when the brewing mechanism in accordance with the present invention is active, the water enters the heat exchanger (30, 30A) through pipe assembly (40) and feed pipe (60) and flows into the hot water pipe (70) in one direction. Therefore, the water from the heat exchanger (30, 30A) flowing into the hot water pipe (70) would be heated to a desired high temperature. Further, the water entering the brewing group (80) all comes from the hot water pipe (80) so as to the temperature of the brewing group (80) is reached the desired temperature quickly without receptive processes for prewarming the brewing group (80). Therefore, the brewing mechanism in accordance with the present invention avoids water entering the brewing group (80) to be over-heated or under-heated and has a property of being thermostatic.

Second, only a proper flux of cold water enters the brewing group (80) through the thermoregulating group (90, 90A, 90C). Rest of cold water enters heat exchanger (30, 30A) through the feed pipe (60) in one direction. At the moment of the brewing mechanism in accordance with the present invention is started, cold water enters the heat exchanger (30, 30A) sequentially through the pipe assembly (40) and the feed pipe (60). All water entering the thermoregulating group (90, 90A, 90C) is unheated water coming from the pipe assembly (40). Thus, the water entering the brewing group (80) through the thermoregulating group (90, 90A, 90C) is all from the pipe assembly (40) but not includes that return flow from the heat exchanger (30, 30A).

Last but not the least, the temperatures of waters entering the brewing group (80) respectively through the hot water pipe (70) and the thermoregulating group (90, 90A, 90C) are more stable. Therefore, it is easier to estimate the temperature of water converge into brewing group (80) by the ratio of the flux of hot water pipe (70) to the thermoregulating group (90, 90A, 90C) and to adjust to a desired temperature for brewing.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A brewing mechanism comprising
a pump having an inlet and an outlet;
a pipe assembly connecting to the outlet of the pump;
a boiler being connected to the pump and having
a reservoir being connected to the pump; and
a heat coil being mounted in the reservoir;
a heat exchanger being mounted in the boiler and having
an inlet;
an outlet; and
at least one heat exchanging unit being mounted through the reservoir of the boiler;
a supply pipe connecting between the outlet of the pump and the reservoir of the boiler;
a feed pipe being mounted between the inlet of the heat exchanger and pipe assembly;
a hot water pipe connecting the outlet of the heat exchanger;
a brewing group connecting to the hot water pipe; and
a thermoregulating group being mounted between the brewing group and pipe assembly.

2. The brewing mechanism as claimed in claim 1, wherein the thermoregulating group has
a thermoregulating pipe connecting between the feed pipe, the brewing group and the pipe assembly; and
a flow control device being mounted between the thermoregulating pipe and the brewing group.

3. The brewing mechanism as claimed in claim 1, wherein the thermoregulating group has
a thermoregulating pipe connecting between the feed pipe, the brewing group and the pipe assembly;
a branch pipe being mounted between the brewing group and the pipe assembly;
two flow control devices being connected respectively to the thermoregulating pipe and the branch pipe; and
two electromagnetic valves being mounted between the flow control devices and the brewing group.

4. The brewing mechanism as claimed in claim 2, wherein the thermoregulating group further comprises at least one cutoff device being mounted between the pipe assembly and the flow control device.

5. The brewing mechanism as claimed in claim 3, wherein the thermoregulating group further comprises two cutoff devices being mounted between the pipe assembly and the flow control devices.

6. The brewing mechanism as claimed in claim 1, wherein the heat exchanger has two heat exchanging units being connected to each other in serial.

7. The brewing mechanism as claimed in claim 5, wherein the heat exchanger has two heat exchanging units being connected to each other in serial.

8. The brewing mechanism as claimed in claim 1, wherein the boiler further has a pressure controller being mounted in the reservoir of the boiler to detect steam pressure in an upper part of the reservoir.

9. The brewing mechanism as claimed in claim 2, wherein the boiler further has a pressure controller being mounted in the reservoir of the boiler to detect steam pressure in an upper part of the reservoir.

10. The brewing mechanism as claimed in claim 3, wherein the boiler further has a pressure controller being mounted in the reservoir of the boiler to detect steam pressure in an upper part of the reservoir.

11. The brewing mechanism as claimed in claim 7, wherein the boiler further has a pressure controller being mounted in the reservoir of the boiler to detect steam pressure in an upper part of the reservoir.
